(19) United States
(12) Patent Application Publication
(10) Pub. No.: US 2009/0062425 A1
(43) Pub. Date: Mar. 5, 2009

(54) Method for producing a deflation-proof pneumatic tire and tire filling compositions thereof

(75) Inventors: Stephen J. Lucka, Perris, CA (US); Larry R. Carapellotti, Mission Viejo, CA (US); Bhanu Patel, Buena Park, CA (US)

Correspondence Address: NIXON PEABODY, LLP, 401 9TH STREET, NW, SUITE 900, WASHINGTON, DC, 20004-2128, US

(73) Assignee: Arnco, Inc., South Gate, CA (US)

(21) Appl. No.: 12/229,148

(22) Filed: Aug. 20, 2008

Related U.S. Application Data
(60) Provisional application No. 60/969,414, filed on Aug. 31, 2007.

(51) Int. Cl. C08L 75/04

(52) U.S. Cl. 523/166

(57) ABSTRACT

The present invention is directed to a method for producing a cured tire filling composition and the composition resulting from such a method. The A component has from about 3 to about 30 weight % of a polyisocyanate comprising polymeric toluene diisocyanate (TDI) or diphenylmethane diisocyanate (MDI) with an average functionality of 2 or greater, from about 10 to about 60 weight % of a high molecular weight polyol or blend of polyols having a hydroxyl number in the range of about 20 to about 56, and the balance of a plasticizer. The amount of plasticizer is an amount sufficient to lower the NCO content of the resulting. A component to be less than 10% and is in the range of from about 10 to about 80 weight %. The B component has from 0 to about 30 weight % of the high molecular weight polyol or blend of polyols, from about 70 to about 99 weight % added water, from about 1 to about 8 weight % of a hydrophilic moiety, and from about 0.1 to about 5 weight % of a catalyst. The resulting elastomer is cured to produce an elastomeric tire filling composition within a pneumatic tire casing having a Durometer hardness in the range of about 5 to 60 (Shore A).

### CROSS REFERENCE TO RELATED APPLICATION

This application claims the benefit of U.S. provisional application Ser. No. 60/969,414, filed Aug. 31, 2007.

### FIELD OF INVENTION

The present invention relates to cured pneumatic tire filling compositions. More particularly, this invention relates to cured filling compositions of polyurethane elastomers using water as a functional replacement for common extenders and a method for producing deflation-proof tires containing the cured filling compositions.

### BACKGROUND OF THE INVENTION

Polyurethane and urea polymers, here after referred to as urethanes, are formed by the formation of covalent bonds between isocyanate terminated molecules and hydroxyl or amine terminated molecules and are utilized in a wide variety of industrial applications. They make up a portion of the polymer group known as thermo sets. These polymers are typically made from two components. One of the components containing the isocyanate terminated molecules is the A component and the other component containing the reactive portion of alcohols and or amines is the B component. In some cases a portion of the reactants are reacted prior to use in the A component forming either pure or quasi prepolymers. The remaining reactants remain in the B component and the method is still classified as a two part formulation.

Industry practices and formulations are widely known and the present invention is limited to industry applications composed of two part systems separating the isocyanate from some or all of the reactants.

A number of these applications require the use of non-reactive molecules in the formulation to either lower costs or to modify the physical properties of the polymer. Non-reactive molecules do not form covalent bonds in the polymer. They are held in the final polymer by either ionic forces or are trapped in the polymer through physical forces. These molecules are classified in most industries as extenders to lower costs, plasticizers to soften the polymer and additives to impart special properties such as fire retarding or reinforcing properties.

The latter non-covalent bonding moieties may form strong hydrogen bonds or other non-covalent forces to affect the final properties of the polymer, but they are classified as not forming polyurethane or polyurea bonds and are thus not part of the thermo sets polymer matrix.

These non-reactive moieties can be added to either the A or B component or can be added as a third component during processing. If such moieties are added as a third component, the system is still referred to as a two part system throughout the description of the present invention.

A common use of the above polyurethanes is in the formation of an economical soft polymer. This polymer is used to fill pneumatic tires which provide flat proofing. This industry refers to these polyurethanes as tire fill, foam fill, flat proofing and other related names. Their use can also include the addition of cut up polymers called chunking or the addition of ground polymers such as urethane or rubber. However, all these polyurethanes are commonly formulated as two part systems and sold as two components to the applicators that fill the tires; see Wyman, U.S. Pat. No. 4,416,844 and Rustad et, U.S. Pat. No. 6,187,125 who teach the use of aromatic oils as at least one of the types of plasticizers used in such an application.

The use of extenders functions to both lower the cost and to soften or plasticize the polymer. One of the common tire fill industrial practices is to utilize petroleum based products as economical extenders, or synthesized molecules as plasticizers. Petroleum based extenders such as aromatic hydrocarbons are widely used due to their economical cost and high solubility in the urethane polymer. However, these products contain a wide variety of molecules that may be carcinogens, and or are associated with environmental health risks. Therefore, their use is coming under growing scrutiny in many polymer markets.

An alternative additive that has economical uses due to lower costs is vegetable and animal based fats and oils. They however have a much lower solubility then aromatic hydrocarbons in urethanes and their total usage is limited.

The next classes of synthesized molecules while being environmentally safer and having good solubility are not as cost effective as extenders. These costs may be only slightly lower then the urethanes reactants themselves as they are synthesized via the fine chemical industry. Common extenders such as isobutyrates, acetates, phosphate esters and phthalates have nearly the same cost as the urethane reactants themselves. Nevertheless, they are still widely used due to their plasticizing ability and high solubility in urethane polymers.

An additional function in some applications is for the extender to impart fire retarding properties to the polymer. Common fire retardants have halogenated molecules and char forming phosphate molecules. These both add significant cost to the polymer and in some cases increase the type of toxic gases being evolved. The common industrial use of hydrocarbon extenders has made fire retarding these polymers even more difficult due to the high fuel contribution of hydrocarbons.

Current common industrial uses of water in urethane polymers are as a solvent in coatings, where it eventually evaporates and does not have a function in the final polymer. A second use of water is in the reaction with isocyanates to produce a urea molecule and to evolve carbon dioxide as a blowing agent. In such a use, the water is involved in cross linking the isocyanate molecules and the evolving gas is either used as a blowing agent in foams or is allowed to escape as in moisture cure coatings. Therefore, water has typically been used in two part urethanes as a solvent or as a reactant.

Water has not been used as an extender, plasticizer or fire retarding additive in urethane polymers due to the fact that water reacts quickly with isocyanates competing with the reactants in the formation of the desired polymer.

The water isocyanate reaction evolves carbon dioxide gas which is not desirable in solid elastomer applications and the reaction of cross linking urea segments may change the polymers desired properties. Therefore, it is common industrial practice to limit or control the amount of water present in two part urethane elastomers to a low percentage.

Lombardi, et al., U.S. Pat. No. 3,605,848 teach the use of water in tire formulations as a curative and blowing agent, but limits its percentage in the formulation to 0.3-0.5%.

There is a need for an economical, non flammable, environmentally safer extender that exhibits good solubility, which would solve these current challenges.

### SUMMARY OF THE INVENTION

The composition of the present invention is directed to a polyurethane composition comprising a catalytically cured mixture of: (a) from about 1 to about 20 parts by weight of a polyisocyanate, toluene diisocyanate (TDI) or diphenylmethane diisocyanate (MDI), wherein the polyisocyanate has an average functionality of 2 or greater; (b) from about 40 to 75 parts by weight of added water; (c) from about 0.5 to 5 parts by weight of a hydrophilic moiety; from about 4 to about 40 parts by weight of a high molecular weight polyol or blend of polyols having a hydroxyl number in the range of about 20 to about 56; and (d) a plasticizer in an amount to bring the amount of the cured mixture to 100 parts by weight and sufficient to lower the NCO content of the resulting polyurethane elastomer to less than 10%. The plasticizer in the resulting elastomer is in the range of from about 10 to about 80 weight %. The cured filling composition has a Durometer hardness in the range of about 5 to 60 (Shore A).

The method of the present invention comprises (a) blending an A component and a B component in a ratio of from 1:1 to 1:3. The A component has from about 3 to about 30 weight % of the 2.0 or greater functionality polyisocyanate, from about 10 to about 60 weight % of the high molecular weight polyol or blend of polyols, and a plasticizer in an amount sufficient to lower the NCO content of the resulting polyurethane elastomer to less than 10%. The B component has from about 0 to about 30 weight % of the high molecular weight polyol or blend of polyols, from about 70 to about 99 weight % added water, from about 1 to about 8 weight % of a hydrophilic moiety, and from about 0.1 to about 5 weight % of a catalyst. The resulting blend is cured to produce an elastomeric tire filling composition within a pneumatic tire casing having the desired Durometer hardness.

### DETAILED DESCRIPTION OF THE INVENTION

The present invention utilizes water as a functional replacement for the non-covalent extenders, plasticizers and additives described in the above Background of the Invention section. Water has a low cost and acts as an economical extender. It possesses high solubility due to its polar nature in urethane polymers and thus can be used in sufficient quantities to render it as a cost effective additive. Water also functions as a plasticizer when it is kept out of the polymer reaction and finally provides excellent fire retarding properties as an additive.

This present invention has overcome the water/isocyanate reaction by limiting the mobility and availability of both the water and isocyanate molecules by adding the water in combination with a highly hydrophilic moiety to the B component. The use of the highly hydrophilic moiety greatly reduces the reactivity of the isocyanate molecules with water. The water is drawn to the hydrophilic moiety and does not appreciably react with the isocyanate molecule when used in accordance with the present invention.

The isocyanate molecules are also limited in mobility and availability to react with water by incorporating them into larger prepolymer molecules and lowering the total isocyanate monomer concentration by dilution with an extender. Specifically in the method of the present invention, the isocyanate molecules are further rendered non-reactive with the water in the B component by diluting the A component with additives to produce a maximum 10% NCO value in the final two part tire fill formulation.

A two part tire fill formulation, which has proven out as a standard in the polyurethane industry, was chosen as a starting point in the method of the present invention. This common two part tire fill formulation is an elastomer based on TDI isocyanate, polyether and polyamine reactants, a hydrocarbon extender and common catalysts having a Durometer hardness in the range of about 5 to 60 (Shore A). Preferably, in the method of the present invention, a combination of methyl hydroxyl propyl cellulose or methyl hydroxyl ethyl cellulose as the hydrophilic moiety and water as the plasticizer were added to this standard formulation, which was adjusted to the desired Durometer hardness with similar curing profiles described below. The resulting two part tire fill formulation of the present invention has been shown to function as a tire fill replacement when the resulting polymer was run side by side in an industrial destructive test.

The method of the present invention limits the ability of the added water to react with isocyanate. This leaves the isocyanate free to crosslink with the formulator's reactants. The water then becomes entrapped in the polymer matrix and acts as an extender. When this formulation is subject to combustion, the water is released and acts as a fire suppressant. The water thereby serves as the following three functions in the present formulation: an extender, plasticizer, and fire retarding additive.

The limitation of the water/isocyanate reaction is partially achieved by having the water ionically bonded and/or drawn to orientate itself towards a highly hydrophilic moiety. Methyl hydroxyl ethyl cellulose was chosen as the hydrophilic moiety due to the low concentration needed. However other types of methylcellulose moieties, e.g., methyl hydroxyl propyl cellulose were shown to also work. It has been found that concentrations of 1-8% by weight of the methylcellulose moieties in the B component were sufficient to stop the water isocyanate reaction. The amount of the hydrophilic moiety to add depends on the water loading of the B component and the processing temperatures of the application. The higher concentrations of 2-4% in the B component were required when the tire fill formulation was subject to greater then 100° F. curing conditions and a 1-2% level was sufficient for 75° F. curing. Concentrations over 4% were made in the lab, but were not tested in actual use but the potential of such higher concentration of up to 8% is clearly stated. As discussed above, all of the water was placed into the B component side of the polymer system. Successful formulations were made with up to 99% by weight water by weight in the B component. The remainder of the B component was the polyols, methylcellulose, reactants and catalyst. The methylcellulose also acted as the curative since it contains hydroxyl groups. The durometer hardness was thus affected by the percentage of methylcellulose and low MW glycol curative as shown in Table 1 below.

Secondly the isocyanate is limited in mobility by reacting some of the isocyanate with some or all of the polyol into a quasi prepolymer and then diluted with an extender. The A component was determined to not react with the water if the final isocyanate NCO content of the A component was kept below 10%.

Lowering the % NCO by forming a quasi prepolymer and adding a diluent limited the mobility and availability of the isocyanate. Both MDI and TDI isocyanates were shown to be useful if the final % NCO was kept below 10%. In the present formulation, the A component was blended with the B component in the standard industrial ratio of 1:1 by volume. The A component was also blended with the B component in the non-standard ratio of 1:2 by volume as shown in Table 1 below. The A/B component ratio can run as high as 1:3.

In the diluted A component, the following three diluents were tested to bring the NCO below the desired maximum percentage: a common aromatic oil, a synthesized molecule, and a vegetable oil. The present formulation allows the formulator the option of entirely replacing current hydrocarbon oils or greatly lowering their use.

As referred to above, fire testing on the final polymer produced a self extinguishing material. The common UL94 test revealed this polymer from Example 2 below would easily pass a V-1 rating. The smoke generation was also greatly reduced from a standard hydrocarbon filled system. Overall, the present formulation has improved fire retardant applications.

The final results demonstrate that common tire fill formulas were produced ranging in durometer from 5 to 60 shore A by varying the amount of methyl cellulose and or curatives while incorporating up to 75% water by weight into the final polymer instead of the common industrial practice of utilizing aromatic hydrocarbon oils at similar percentages.

### CONTROL AND EXAMPLES 2-6a

The control and examples and discussion which follow further illustrate the performance of the tire filling compositions of the present invention. The control and examples are for illustrative purposes and are not meant to limit the scope of the claims in any way. The tire filling compositions of each of the controls and examples consisted of a two component mixture. Most of the isocyanate and polyol blend components were metered at the standard 1 to 1 by volume ratio and mixed through a static mixer as the two component mixture was pumped into a tire to set up and cure at room temperature over a period of several days. Each component was made by proportionately blending the specific amounts of the materials listed in the Table 1. Tables 1 summarizes Control 1 and Examples 2, 2a, 3, 3a, 4, 4a, 5, 6, and 6a illustrating the preferred and practical embodiments of the present invention.

Preferably, the filling composition of the present invention comprises a catalytically cured mixture of: (a) from about 3 to about 10 parts by weight of the polyisocyanate; (b) from about 45 to 55 parts by weight of added water; (c) from about 1 to 2 parts by weight of a hydrophilic moiety; (d) from about 10 to about 20 parts by weight of the high molecular weight polyol or blend of polyols a plasticizer; and (d) an amount of the plasticizer to bring the amount of the cured mixture to 100 parts by weight and to lower the NCO content of the A component to less than 10%. The plasticizer can be added as a third component after the A and B components have been blended.

The following tabulates the specific materials used in each of the A and B blend components listed in Table 1 below.
Polyol A: 6000-6500 MW Multranol 3901 triol supplied by Bayer
Polyol B: 4500-5000 MW Multranol 434 triol supplied by Bayer
Isocyanate A: Toluene Diisocyante 80/20 supplied by Bayer
Isocyanate B: Rubinate 1820 polymeric MDI supplied by Huntsman
Isocyanate C: Rubinate 1234 pure MDI pre-polymer supplied by Huntsman
Water: Water supplied by local municipality
Plasticizer B: Viplex 530-A process oil supplied by Crowley Oil Company
Plasticizer C: Texanol isobutyrate (TXIB) supplied by Eastman Company
Low MW diol: Diethylene glycol supplied by Ashland Chemical
Polyamine: meta-phenylene diamine
Catalyst A: magnesium oxide
Catalyst B: Formrez UL-22 supplied by Witco
Hydrophilic moiety A: methyl hydroxy ethyl cellulose MW15000 supplied by Wolf Cellulosics
Hydrophilic moiety B: methyl hydroxy propyl cellulose MW6000 supplied by Wolf Cellulosics

TABLE 1

| | Control/Examples | | | | | | | | | |
|---|---|---|---|---|---|---|---|---|---|---|
| | 1 | 2 | 2a | 2b | 3 | 4 | 4a | 5 | 6 | 6a |
| | wt % | wt % | wt % | wt % | wt % | wt % | wt % | wt % | wt % | wt % |
| A Component | | | | | | | | | | |
| Isocyanate A | 9 | 9 | 9 | 9 | 9 | 14 | | 6 | 6 | 6 |
| Isocyanate B | | | | | | 7 | | | | |
| Isocyanate C | | | | | | | 27 | | | |
| Polyol A | 31 | 31 | 10 | 61 | 31 | 22 | 28 | 34 | 34 | 34 |
| Plasticizer B | 60 | 60 | 81 | 30 | | | | 60 | 60 | 60 |
| Plasticizer C | | | | | 60 | 57 | 45 | | | |
| Total % | 100 | 100 | 100 | 100 | 100 | 100 | 100 | 100 | 100 | 100 |
| % NCO | 3.94 | 3.94 | 4.47 | 3.19 | 3.94 | 8.77 | 4.62 | 2.43 | 2.43 | 2.43 |
| B Component | | | | | | | | | | |
| Water | 0.3 | 96 | 96 | 96 | 96 | 84 | 96 | 96 | 94.8 | 97.8 |
| Polyol A | 54 | | | | | | | | | |
| Polyol B | | | | | | 20 | | | | |
| Low MW Diol | | | | | | 2 | | | | |
| Polyamine | 1.2 | | | | | | | | | |
| Plasticizer B | 44.3 | | | | | | | | | |
| Catalyst A | | 2 | 2 | 2 | 2 | 2 | 2 | 2 | 1 | 1 |
| Catalyst B | 0.2 | | | | | | | | 0.2 | 0.2 |
| Hydrophillic Moety A | | 2 | 2 | 2 | 2 | 2 | 2 | 2 | | |
| Hydrophillic Moety B | | | | | | | | | 4 | 1 |
| Total % | 100 | 100 | 100 | 100 | 100 | 100 | 100 | 100 | 100 | 100 |
| Durometer Shore A | 30 | 30 | 28 | 27 | 30 | 55 | 35 | 8 | 20 | 10 |
| A Component-B | 51/49 | 50/50 | 50/50 | 50/50 | 50/50 | 50/50 | 50/50 | 33/67 | 50/50 | 50/50 |
| Component Ratio by Wt. | | | | | | | | | | |

Control 1 is a standard 30 shore A tire fill formula common to the tire fill industry and is based on an aromatic hydrocarbon plasticizer. See Table 3, Control 2 of Rustad et, U.S. Pat. No. 6,187,125 for further example of a control without the modifications of the present invention.

In Example 2, a 30 shore A tire fill formula was made and proven to work in a common tire industry dynamic test.

The tire formula was formulated to be 1:1 by volume so the tire could be filled with a standard tire fill resin pump. The filled tire was then tested on a tire dynamometer at Smithers test labs to replicated road use conditions.

In this Example 2, the A component consisting of a 2.0 functionality TDI monomer supplied by Bayer Corporation was blended with a B component consisting of a polypropyleneglycol polyol having a molecular weight of 6000 supplied by Bayer in a specified ratio. To this blend prior to curing was added aromatic hydrocarbon oil supplied by Crowley Chemical. The above three components were blended to reduce the available NCO to be less then 10% and the A component was run at a 1:1 volume against the B component.

The B component consisting of local tap water was blended with the hydrophilic moiety, methyl hydroxy ethyl cellulose supplied by Wolff Celluosics and the catalyst, magnesium oxide supplied by R D Abbot Co., Inc.

The above two component formulation forms a 30 shore A tire fill polymer that is easily pumped into common tires for flat proofing applications.

Examples 2a -2b show the ability to control the final % NCO with either reacting the isocyanate with the polyol or diluting with plasticizer.

In Example 3, the same B component from Example 2 was blended with an A component in which the aromatic hydrocarbon oil was replaced with an isobutyrate from Ashland Chemical to lower the NCO below 10%. This resin was also 1:1 by volume and easily pumped into tires via common pumping equipment. This example shows the potential to completely remove aromatic hydrocarbon oils from tire fill formulations.

In Example 4, the A component was blended replacing some of the 2.0 functional TDI monomer with a 2.3 functional MDI supplied by Bayer Corporation. The B component was the same as Example 2 plus it contained a common glycol cross linker and polyol to increase the hardness of the polymer. The glycol used was diethylene glycol supplied by Ashland Chemical. The final polymer was a 55 shore A and was also easily pumped into tires.

Example 4a shows the use of an alternative 100% MDI in the A component blended down to less the 10% NCO.

Example 5 was run utilizing a less then 1:1 by volume ratio of A to B side to show that increased water levels in the final polymer could be achieved for very low durometer polymers and increased fire retarding properties. In this example, polymers with 70% water by weight were produced but not pumped into tires due to the equipment available at the time.

Example 6 and 6a were run to show alternative methylcellulose and catalyst can be used in the method of this invention and their concentrations varied. The 4% cellulose level required for high temperature curing over 200° F. and the 1% level for ambient curing below 100° F.

The above examples show how the method of this invention can be used with a variety of TDI and MDI polyurea and polyurethane tire fill formulations. In doing so, a fire rating of UL94 V1 was achieved by replacing the aromatic oil with the water filled B component. Complete removal of the aromatic oil from the A sides further produced polymers with no harmful hydrocarbons. The addition of cross linkers or the lowering of the isocyanate portion was proven to form polymers in the range of 5-60 shore A. Lastly the additives such as anti oxidants and biocides can easily be added to the B component to increase shelf life and long term physical properties.

Having disclosed exemplary embodiments, modifications and variations may be made to the disclosed embodiments while remaining within the scope of the invention as described by the following claims.

What is claimed is:

1. A polyurethane composition comprising a catalytically cured mixture of: (a) from about 1 to about 20 parts by weight of a polyisocyanate, toluene diisocyanate (TDI) or diphenylmethane diisocyanate (MDI) or blended with diphenylmethane diisocyanate or a modified diphenylmethane diisocyanate, wherein the polyisocyanate has an average functionality of 2 or greater; (b) from about 40 to 75 parts by weight of added water; (c) from about 0.5 to 5 parts by weight of a hydrophilic moiety; from about 4 to about 40 parts by weight of a high molecular weight polyol or blend of polyols having a hydroxyl number in the range of about 20 to about 56; and (d) a plasticizer in an amount to bring the amount of the cured mixture to 100 parts by weight and sufficient to lower the NCO content of the resulting polyurethane elastomer to less than 10%.

2. The composition of claim 1, wherein said elastomer has about 10 to about 80 weight % of a plasticizer and a Durometer hardness in the range of about 5 to 60 (Shore A).

3. The composition of claim 2, wherein said elastomer is used to fill the casing of pneumatic tires.

4. The composition of claim 1, wherein said hydrophilic moiety is a methylcellulose.

5. The composition of claim 4, wherein said a methylcellulose is methyl hydroxyl ethyl cellulose or methyl hydroxylpropyl cellulose.

6. A method for producing a polyurethane composition which comprises:
(a) blending an A component and a B component, said A component having from about 3 to about 30 weight % of a polyisocyanate comprising polymeric toluene diisocyanate (TDI) or diphenylmethane diisocyanate (MDI), wherein said polyisocyanate has an average functionality of 2 or greater, from about 10 to about 60 weight % of a high molecular weight polyol or blend of polyols having a hydroxyl number in the range of about 20 to about 56, and a plasticizer in an amount sufficient to lower the NCO content of the resulting A component to be less than 10%, and said B component having from about 0 to about 30 weight % of a high molecular weight polyol or blend of polyols having a hydroxyl number in the range of about 20 to about 56, from about 70 to about 99 weight % water, from about 1 to about 8 weight % of a hydrophilic moiety, and from about 0.1 to about 5 weight % of a catalyst; and
(b) curing the resulting polyurethane elastomer having a Durometer hardness in the range of about 5 to 60 (Shore A.

6. The method of claim 6, wherein said plasticizer is added to the blend of component A and component B in an amount sufficient to bring the total amount of the blend to 100 weight %.

7. The method of claim 6, wherein 0 to about 5 weight % of a low molecular weight diol or polyamine is added to the B component.

8. The method of claim 1, wherein said elastomer is used as a deflation-proof filling composition in pneumatic tires.

9. The composition of claim 1, wherein said hydrophilic moiety is a methylcellulose.

10. The composition of claim 9, wherein said a methylcellulose is methyl hydroxyl ethyl cellulose or methyl hydroxylpropyl cellulose.
